(19) United States
(12) Patent Application Publication
(10) Pub. No.: US 2014/0037875 A1
(43) Pub. Date: Feb. 6, 2014

(54) Shrink Film Labels Including Adhesive

(71) Applicant: Thomas G. Scully, Charlestown, IN (US)

(72) Inventor: Thomas G. Scully, Charlestown, IN (US)

(73) Assignee: MULTI-COLOR CORPORATION, Batavia, OH (US)

(21) Appl. No.: 13/565,293

(22) Filed: Aug. 2, 2012

(51) Int. Cl. B65B 53/02; B32B 3/10; G09F 3/10; C09J 7/02

(52) U.S. Cl. 428/34.9; 428/349; 428/195.1; 428/200; 428/343

(57) ABSTRACT

A label having an adhesive applied proximal to an inner surface of a shrink film (such as a shrink sleeve), which is not transferred to labeling apparatus during application of the shrink label to an article. Thus, the shrink sleeve does not result in a build-up of adhesive on label application apparatus, thereby preventing apparatus downtime; and cannot be removed from the article to which it is applied, (or cannot be removed without damage being done to the label), thereby preventing removal and re-use of the shrink sleeve on counterfeit goods.

### FIELD OF THE INVENTION

The present invention relates to shrink films for application to various articles, and in particular, to shrink films having an adhesive that are used to label articles.

### BACKGROUND OF THE INVENTION

This section is intended to introduce the reader to various aspects of art that may be related to various aspects of the present invention, which are described and/or claimed below. This discussion is believed to be helpful in providing the reader with background information to facilitate a better understanding of various aspects of the present invention. Accordingly, it should be understood that these statements are to be read in this light, and not as admissions of prior art.

Shrink films, which may be used for shrink sleeves and shrink wraps, are used in labeling, often as an alternative to pressure-sensitive labels, heat-transfer labels, in-mold labels, and other labels. Shrink labeling involves sizing a shrink film, which may be in the form of a tubular shrink sleeve, to a particular article. Then one shrinks the film to snugly wrap the article within the shrink sleeve. The article may be any item, such as a container or multi-pack, for example. The shrinking process is generally accomplished by the application of heat or steam to the shrink sleeve. Further processing may include heat-sealing any unsealed portions of the shrink sleeve and/or covering the article contents with a shrink cover.

The material used for shrink films may depend on the shape and weight of the article and its contents. The shrink film may include polyethylene terephthalate, polyethylene terephthalate glycol, polyvinyl chloride, oriented polystyrene, polyolefin, or combinations thereof for example. The film has an inherent tension that is released by heating the film from the outside in a shrink oven. Shrink films may be produced in forms that may be oriented monoaxially (in a single direction). Once formed into a shrink sleeve (for example), it can be positioned around an article and heated. As the film cools, it shrinks snugly around the article. This shrinkage applies a very slight pressure to the article, which aids in holding the shrink film to the article. For this reason, adhesives are not necessary for shrink film label applications.

To prepare a shrink sleeve label, graphics, such as pictures, logos, and/or text for labels, may be reverse-printed on the shrink films (e.g., on the inner surface of the shrink film) and the shrink films then seamed, thereby forming a shrink sleeve. In general, shrink films are reverse-printed using flexographic or rotogravure printing technology. A master roll of shrink film is prepared with a number of label copies across its surface. The particular number of labels depends upon the size of the label copy and the width of the master roll. The printed rolls are then slit-cut, thereby forming individual rolls containing one copy of the label only. The slit rolls are then folded and overlapped, and seamed at the edge, forming a shrink sleeve that is wound on a core. The finished rolls are packaged and delivered to a particular location where each of the shrink sleeves will be applied to an article. These shrink sleeves are commonly used for full body decoration (though this is not the only use for such shrink sleeves).

As described above, shrink sleeves are usually applied to an article without any adhesive. In these embodiments, a shrink sleeve is simply shrunk around an article and the force provided by the constriction of the sleeve around the article (upon shrinking) holds it to the article. The absence of adhesive is generally considered one of the advantages of shrink sleeve labels, because the lack of adhesive reduces the number of materials used in producing the shrink sleeve label, reduces the cost of the shrink sleeve label, reduces the thickness of the shrink sleeve label, and simplifies the process for applying the shrink sleeve label to an article. However, with no adhesive, some shrink sleeves can be removed from the articles to which they are applied with relative ease. The removed shrink sleeve labels can then be applied to other articles to create counterfeit articles.

Thus, it would seem that one way to prevent removal of shrink films, such as shrink sleeves, (and thus reduce or prevent the counterfeit goods issue), is by including an adhesive proximal to the inner surface of the shrink sleeve to adhere the shrink sleeve to an article (e.g., on the inner surface, and/or on any ink design layer or other layer applied to the inner surface). However, there are drawbacks with applying an adhesive to the inner surface of a shrink sleeve. For example, the adhesive must be applied proximal to the inner surface of the shrink sleeve prior to slipping the shrink sleeve over the article and heating it to cause the shrink sleeve to shrink around the article. However, some of the process by which shrink sleeves are applied to articles causes the adhesive to be removed from the inner surface of the shrink sleeve and build up on the apparatus used for label application. This results in deficient label application equipment and equipment down time. Often, adhesive can build up on an applicator apparatus and cause the machine to be shut down within minutes of beginning application of labels to articles.

More specifically, in applying a shrink sleeve to an article, the article (which is to receive the shrink sleeve) is guided underneath a shrink sleeve bullet (which is a portion of a label application apparatus that facilitates opening of the shrink sleeve to a tubular form for subsequent application to an article). The bullet has a generally tubular shape, with a flattened blade section at one end. The bullet is aligned with the shrink sleeve, with the blade end most proximal the shrink sleeve. This shrink sleeve is then slipped past the bullet, with the shrink sleeve being opened by the blade end, in order to promote its tubular form and to guide the shrink sleeve over the article. After the shrink sleeve is guided and positioned around the article, the article and the loose shrink sleeve proceed through a shrink tunnel, which shrinks the shrink sleeve against the article through the application of heat.

When adhesive is present proximal to the inner surface of the shrink sleeve prior to application to an article, the adhesive, or at least a portion thereof, tends to be removed from the shrink sleeve and transferred to the bullet by physical contact therebetween as the shrink sleeve slips over the bullet. This adhesive builds up on the bullet and eventually interferes with proper execution of the apparatus. Ultimately, the buildup of the adhesive on the bullet will become so great that the machine will be completely rendered incapable of applying shrink sleeves to articles and thus will stop working properly. This can occur within minutes of running the apparatus.

Further, the transfer of adhesive from the shrink sleeve to the bullet also interferes with the application of the shrink sleeves to articles. In other words, the physical removal of some of the adhesive by the bullet results in less adhesive being associated with the shrink sleeve, and thus a weaker bond of the shrink sleeve to the article. This results in reintroducing the concept of ease of the removal of the shrink sleeve for possible use on counterfeit goods.

To ameliorate the buildup of the adhesive, which disrupts proper application of the shrink sleeve to the article and prevents the apparatus from working correctly, one has to periodically and frequently shut down the apparatus and clean the buildup of adhesive from the bullet. This results in downtime for the labeling line, which is not cost effective. And, as described above, in instances where the apparatus becomes ineffective within minutes, the use of adhesives on shrink sleeve labels is not possible.

Further, some adhesives that one might use for shrink sleeve labels exhibit poor bond strength even if they are applied. When using adhesives on labels, water-based adhesives are generally preferred over solvent-based adhesives [due to the lack of solvents, volatile organic compounds (VOCs), and other potentially harmful and difficult to deal with aspects that are present in solvent-based adhesives]. However, application of shrink sleeves involves the use of steam tunnels. The steam negatively affects the ability of the water-based adhesives to form a strong bond between the article and label. Further, water-based adhesives tend to have less cohesive bond strengths than some other types of adhesives. Thus, one may need to move away from water-based adhesives, and toward solvent-based adhesives, which may lead to further potential drawbacks (such as those described above).

Further still, there are drawbacks that arise from the application of the adhesive proximal to the inner surface of the shrink sleeve itself (i.e., prior to any problems that arise once the shrink sleeve is slipped over a bullet). For example, some adhesives can only be applied at high temperatures. For example, the temperatures for application of hot melt adhesives (often in excess of 300° F.) are temperatures that negatively affect shrink films (e.g., temperatures at which the shrink film will begin to shrink or deform). Thus, the actual application of adhesive proximal to the inner surface of the shrink sleeve may occur at a temperature that prematurely begins to shrink the film.

### SUMMARY OF THE INVENTION

Certain exemplary aspects of the invention are set forth below. It should be understood that these aspects are presented merely to provide the reader with a brief summary of certain forms the invention might take and that these aspects are not intended to limit the scope of the invention. Indeed, the invention may encompass a variety of aspects that may not be explicitly set forth below.

The present invention overcomes and eliminates the drawbacks described above in the Background of the Invention. It does so, in one aspect, by providing a label having an adhesive applied proximal to an inner surface of a shrink film (such as a shrink sleeve), which is not transferred to labeling apparatus during application of the shrink label to an article. Thus, this aspect of the present invention provides a shrink sleeve that (1) does not result in a build-up of adhesive on label application apparatus, thereby preventing apparatus downtime, and (2) cannot be removed from the article to which it is applied, (or cannot be removed without damage being done to the label), thereby preventing removal and re-use of the shrink sleeve on counterfeit goods. In other words, the adhesive binds the shrink sleeve to the article such that it cannot be removed therefrom without damaging or destroying the shrink sleeve to an extent that it cannot be re-used (such as with counterfeit goods).

This is accomplished, in one aspect of the present invention, by providing an adhesive of a particular formulation (described in greater detail below) that results in the adhesive not being substantially transferred from the shrink film to a bullet (or other part of equipment) during label application, and so does not build up on a label application apparatus during application of the shrink film to an article. In another aspect of the present invention, the adhesive may be applied in a particular pattern such that it is not substantially transferred from the shrink film to a bullet (or other part of equipment) during label application, and so does not build up on a label application apparatus during application of the shrink film to an article. And in yet another aspect of the present invention, particular application apparatus and/or application parameters may be used that prevent adhesive from being substantially transferred from the shrink film to a bullet (or other part of equipment) during label application. These aspects of the present invention may be used individually or in combination with one another. Further, although the label will be destroyed and/or rendered incapable of re-use when removed, it can be removed while not impacting the recyclability of the article.

More specifically, in one aspect of the present invention, the adhesive may be a solvent-based adhesive including a vinyl acetate resin, such as ethylene vinyl acetate. As is known to those of ordinary skill in the art, solvent-based adhesives generally contain a higher level of organic solvents than non-solvent-based adhesives. The function of organic solvents in an adhesive relates to certain properties they bring—they facilitate the application and drying of the adhesive, and the formation of a regular film of adhesive. During application and drying, the solvent evaporates. Because the formulation of this embodiment is solvent-based, it does not suffer the poor-bonding characteristics of water-based adhesives (described in the Background).

In another aspect of the invention, this adhesive may be a warm melt adhesive. Warm melt adhesives exhibit properties of hot melt adhesives and versatility of hot melt adhesives, but can be applied at much lower temperatures without a loss of performance relative to hot melt adhesives. Some advantages of warm melt adhesives include reduced cost of the adhesives; reduction or removal of hazardous air pollutants (HAPs) and VOCs from the press diluent; use of the same devices for application; and increased press speed because less drying capacity is required. The adhesive may be a solvent-based adhesive. However, even though such an embodiment may use solvent-based adhesives (as opposed to water-based adhesives), the drawbacks typically associated with solvent-based adhesives is reduced.

Thus, this aspect of the present invention provides a particular warm-melt adhesive for use with shrink films, which incorporates some advantages of hot melt adhesives, while being suitable for use with shrink films, such as, for example, having lower application temperatures and lower temperatures at which tackiness of the adhesive develops. Thus, as the particular formulation exhibits these lower temperatures, the adhesive can be applied proximal to the inner surface of a shrink film without prematurely deforming/shrinking the shrink film.

In another aspect of the present invention (described briefly above), the adhesive may be applied proximal to the inner surface of the shrink sleeve in a pattern that prevents transfer of adhesive from shrink sleeve to bullet (or other portion of label application apparatus). In one embodiment, the adhesive may be applied proximal to the inner surface of the shrink sleeve in a “strip pattern,” as opposed to a full flood coating of adhesive. In certain embodiments, the application of the adhesive in a strip pattern assists in preventing a substantial amount of adhesive being removed from the shrink sleeve and building up on the bullet of the label application apparatus. For example, the adhesive may be applied in a plurality of distinct strips that are linear and substantially parallel to adjacent strips with a gap of no adhesive in between. The strips may be applied in a direction that is parallel to the longitudinal axis of the bullet that the shrink sleeve passes over during the application process. As a result, the application of shrink sleeve to article reduces and/or eliminates rapid build-up of adhesive on the bullet due to transfer from the shrink sleeve.

Another aspect of the present invention provides a method of applying a shrink sleeve over an article. The method includes providing a shrink sleeve having a longitudinal (which is an axis of symmetry when the sleeve is “open”) and at least one decoration that is visible when one views the outer surface of the shrink sleeve, with an adhesive proximal to the inner surface of the shrink sleeve. The adhesive used may be of a particular formulation that it is not substantially removed from the shrink sleeve and does not build up on a label application apparatus during application of the shrink sleeve to an article. Additionally or alternatively, the adhesive may also be in a particular pattern (such as a strip pattern), to further prevent build-up of adhesive on a label application apparatus. One also provides an article, the article having a top end, a bottom end, a side surface, and a longitudinal axis passing through a centerpoint of the top end and a centerpoint of the bottom end. The article is oriented such that its longitudinal axis is substantially parallel to (and possibly coaxial with) the axis of symmetry of the shrink sleeve. The shrink sleeve is positioned over and around the article such that at least a portion of the article is disposed within and substantially surrounded by the shrink sleeve. And the shrink sleeve is shrunk such that the shrink sleeve constricts around at least a portion of the side surface of the article, thereby positioning the shrink sleeve such that the at least one decoration is visible when one views the outer surface of the shrink sleeve.

In applying a shrink sleeve label to an article (described above), certain embodiments may include one or more various apparatus and/or application conditions. For example, in one embodiment, the adhesive is preconditioned at about 140° F., for 24 hours prior to coating onto the inner surface of the shrink film. In another embodiment, certain equipment may be used during application. For example, a heated adhesive pan, heated pump, and heated tank can be used when applying an adhesive (such as a warm melt EVA based adhesive). In another embodiment, the adhesive can be applied to shrink film at about 120° F. Additionally or alternatively, aspects of the present invention may include certain temperature ranges or temperatures at which the adhesive is held or applied. For example, in one embodiment, there may be an application temperature (adhesive in pan temperature) in a range of about 110° F. to 130° F. Additionally, in this embodiment, there may be a pump temperature having a minimum of 120° F., a tank temperature having a minimum of 140° F., and a web temperature exit target in a range of 110° F. to 130° F. In one particular embodiment, the application temperature may be about 120° F., and the web temperature exit target may be about 120° F. Further, in one embodiment, the adhesive can be pre-conditioned by heating to a temperature in the range of about 130° F. to about 150° F. twenty-four hours prior to the coating application. In one specific embodiment, this preconditioning may occur at a temperature of about 140° F.

Additional characteristics of the shrink sleeve of the present invention will be apparent from the following detailed drawings and description of the invention.

### BRIEF DESCRIPTION OF THE DRAWINGS

The accompanying drawings, which are incorporated in and constitute a part of this specification, illustrate embodiments of the invention and, together with the general description of the invention given above and the detailed description of the embodiments given below, serve to explain the principles of the present invention.

FIG. 1A is a cross-sectional view of an embodiment of a label in accordance with principles of the present invention.

FIG. 1B is a cross-sectional view of a second embodiment of a label in accordance with principles of the present invention.

FIG. 1C is a cross-sectional view of a third embodiment of a label in accordance with principles of the present invention.

FIG. 1D is a cross-sectional view of the label of FIG. 1B applied to an article in accordance with principles of the present invention.

FIG. 2 is a view of a label showing an exemplary pattern of adhesive applied to a surface of the shrink film of the label.

FIG. 3 shows a label as applied to an article.

FIG. 4A is a perspective view of an apparatus in accordance with the principles of aspects of the present invention, including a heated gravure tray and sleeve for application of adhesive.

FIG. 4B is a cross-sectional view of the apparatus of FIG. 4A, taken along line 4B-4B of FIG. 4A.

FIG. 5 is a top view of a gravure tray including a heating element, in accordance with the principles of aspects of the present invention.

FIG. 6 is a schematic showing the method of application of adhesive to the label.

FIG. 7 is a schematic showing the typical apparatus and process for applying a shrink sleeve to an article.

### DETAILED DESCRIPTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

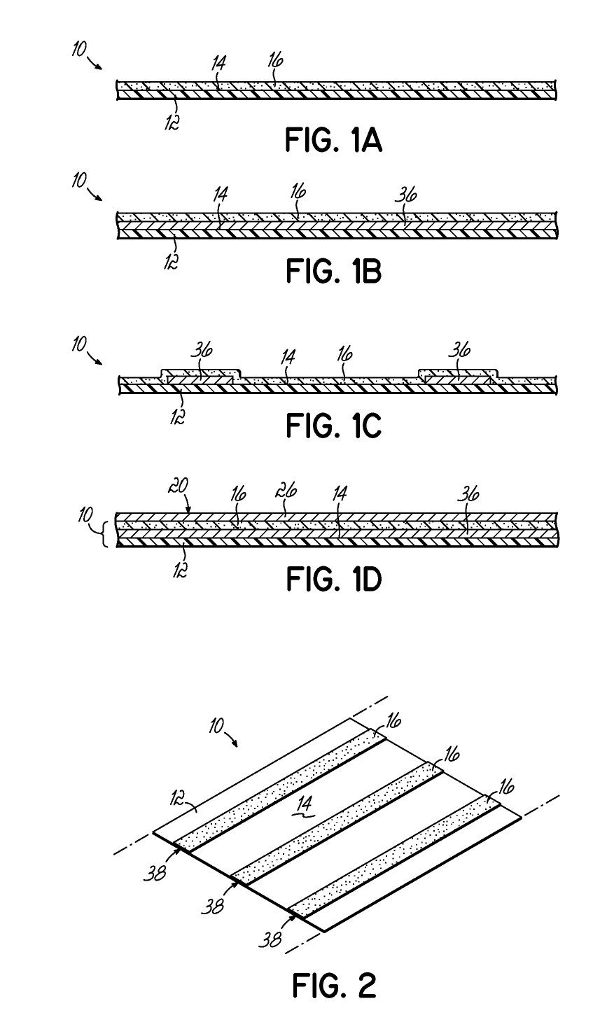

Referring now to the Figures (and particularly to FIGS. 1A-3), one aspect of the present invention provides a label 10 including a shrink film 12 (such as can be used to form a shrink sleeve) having an inner surface 14, with an adhesive 16 applied proximal to the inner surface 14. (As used herein, the “inner surface” of the shrink film refers to the surface of the shrink film 12 that would be in facing relationship with a surface 18 of an article 20 to which the label 10 would be applied—see at least FIG. 1D for the surface 18 of the article 20.) Thus, this aspect of the present invention provides a label 10 including a shrink film 12 or shrink sleeve 12 that cannot be removed from an article 20 to which it is applied, (or cannot be removed without damage being done to the label 10), thereby preventing removal and re-use of the label 10 (such as on counterfeit goods). In other words, the adhesive 16 binds the shrink sleeve 12 to the article 20 such that it cannot be removed therefrom without damaging or destroying the shrink sleeve 12 to an extent that it cannot be re-used. However, although the label will be damaged or destroyed and/or rendered incapable of re-use when removed, it can be removed while not impacting the recyclability of the article.

Herein, the reference number “12” is used for both “shrink film” and “shrink sleeve.” This is not to suggest that all shrink films are shrink sleeves. As is known to those of skill in the art, shrink films may be used without seaming into a shrink sleeve. Shrink films may also be used for shrink wraps (and so the shrink label contemplated herein is not limited to a label that may be positioned around a side surface of an article, but may also include full wraps of articles, for example). However, as the illustrated embodiment shows a shrink sleeve that includes a shrink film, the number “12” is used for both as a matter of convenience, and not in a limiting manner. Additionally, while certain illustrated embodiments depict a shrink sleeve, those skilled in the art will recognize that the principles of the invention described herein are not limited to shrink sleeves, but the invention may encompass shrink wraps and/or any label that includes a shrink film.

Further, in one aspect of the present invention, the adhesive 16 used may be of a particular formulation (described in greater detail below) that it is not substantially transferred from the shrink film 12 to label application apparatus or a portion thereof (such as a bullet) during label application, and so does not build up on label application apparatus during application of the shrink sleeve 12 to an article 20. Alternatively, or additionally, in another aspect of the present invention, the adhesive 16 may be applied proximal to the inner surface 14 of shrink sleeve 12 in a particular pattern such that it is not substantially transferred from the shrink film 12 to a bullet (or other part of equipment) during label application, and so does not build up on a label application apparatus during application of the shrink film 12 to an article 20. And in yet another aspect of the present invention, alternatively or additionally, particular application apparatus and/or application parameters may be used that prevent adhesive 16 from being substantially transferred from the shrink film 12 to a bullet (or other part of equipment) during label application.

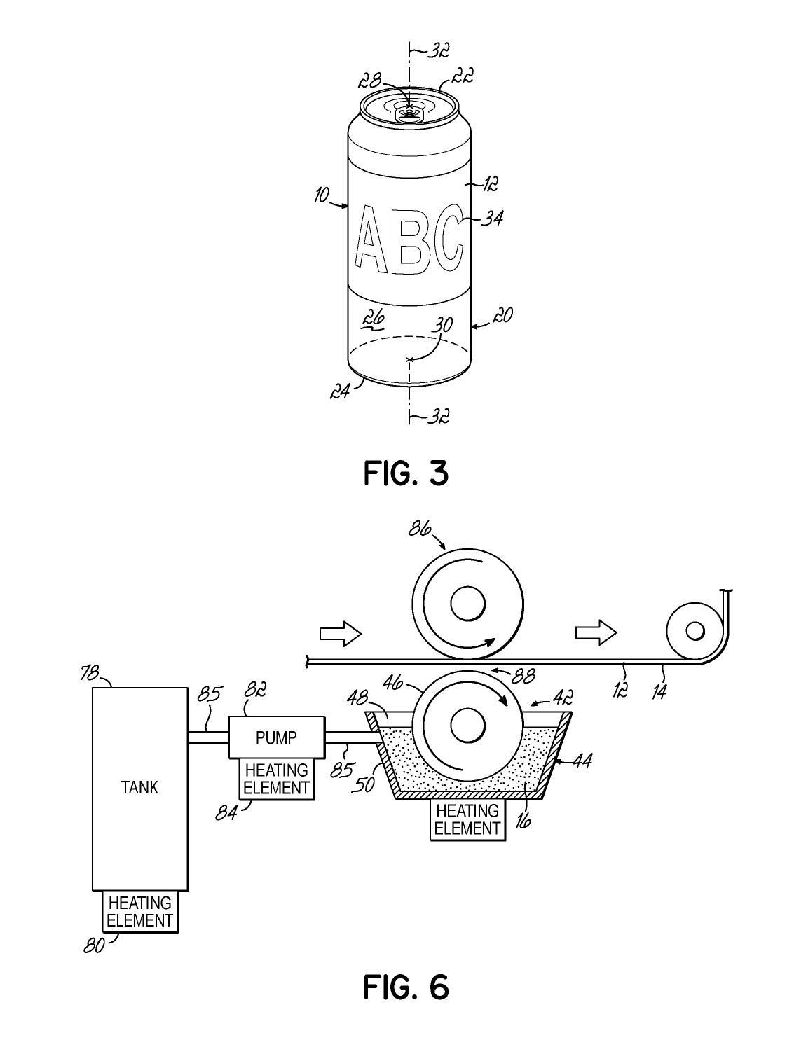

A labeled article for packaging an item or items is shown in FIG. 3. This labeled article includes a shrink sleeve 12 and an article 20. The article 20 has a top end 22, a bottom end 24, and a side surface 26. The article 20 may further include a centerpoint 28 of the top end 22 and a centerpoint 30 of the bottom end 24 with a longitudinal axis 32 passing therethrough.

As shown in FIGS. 1A-3, the label 10 includes a shrink film 12 (which may form a shrink sleeve). A shrink film 12 may include polyethylene terephthalate, polyethylene terephthalate glycol, polyvinyl chloride, oriented polystyrene, polyolefin, or combinations thereof, for example. The shrink film has an inherent tension that is released by heating the film from the outside in a shrink oven. The film may be oriented monoaxially (in a single direction). Decorations 34, such as pictures, logos, and/or text for labels, may be reverse-printed on the shrink film and the shrink films may be seamed, thereby forming the shrink sleeve 12. The shrink film may be reverse-printed using flexographic and rotogravure printing technology, for example. (Alternatively, the printing may occur proximal to an outer surface of the shrink film 12; i.e., the surface of the shrink film 12 that is not in confronting, facing relationship with a surface of the article when the shrink film 12 is associated with the article.)

The shrink sleeve 12 is shrunk around at least the side surface 26 of the article 20, and includes at least one visible decoration 34 on a surface of the shrink sleeve 12. Such a decoration 34 may be provided by various inks well known to those skilled in the art. These may be reverse-printed on or proximal to the inner surface 14 of the shrink films 12 (i.e., the surfaces that will be applied toward the surface of the article 20). Alternatively, the inks may be applied on or proximal to the outer surface of the shrink films. “Reverse-printed on” or “applied on,” as used here, means there is direct contact between the inks and the surface of the shrink film. “Reverse-printed proximal to” or “applied proximal to,” as used here, means that although the inks are applied to the same side as a surface of the shrink film, it is not necessary that there be any direct contact between the inks and the surface (although there may be). For example, another layer, or layers, may be disposed between the inks and the surface that the inks or inks are “applied proximal to.”

In the illustrated embodiment (as seen in FIG. 3), the decoration 34 is visible to an observer on a side surface of the shrink sleeve 12, and thus the article 20, once the shrink sleeve 12 is associated with the article 20, such as by being shrunk around the article 20. The decoration 34 of the illustrated embodiment is shown as being visible only partially circumferentially about the shrink film, and thus the article 20. However, in alternate embodiments, any decoration 34 may be present substantially about the entire circumference of the shrink sleeve 12, and thus the article 20. In still other embodiments, the shrink sleeve 12 may provide a plurality of visible decorations 34 about a surface of the shrink sleeve 12.

Referring now to FIGS. 1A-D and 2, the adhesive 16 is disposed proximal to an inner surface 14 of the shrink sleeve 12. “Disposed proximal to,” as used here, means that although the adhesive 16 is applied to the same side as a surface (i.e., the inner surface 14) of the shrink sleeve 12, it is not necessary that there be any direct contact between the adhesive 16 and the surface (although there may be). For example, another layer or layers, such as an ink layer 36 (see FIG. 1B), may be disposed between the adhesive 16 and the surface that the adhesive 16 is “disposed proximal to.” Alternatively, the adhesive 16 may be directly adjacent more than one layer—such as the shrink film 12 and ink layer 36 (see FIG. 1C).

The adhesive 16 applied proximal to the inner surface 14 of shrink sleeve 12 may be adapted to contact a surface of the article 20. The adhesive 16 binds the shrink sleeve 12 to the article 20 such that it cannot be removed therefrom without damaging or destroying the shrink sleeve 12 to an extent that it cannot be re-used. Further, as described previously, the adhesive 16 used may be of a particular formulation such that it cannot be substantially removed from the shrink sleeve 12 and does not build up on a label application apparatus during application of shrink sleeve 12 to article 20. More specifically, in one embodiment, the adhesive 16 may be a solvent-based adhesive including a vinyl acetate resin, such as ethylene vinyl acetate. As is known to those of ordinary skill in the art, ethylene vinyl acetate (also known as EVA) is a copolymer of ethylene and vinyl acetate. Ethylene is the simplest alkene, and is an unsaturated hydrocarbon with the formula C₂H₄. Vinyl acetate is an organic compound with the formula CH₃COOCH═CH₂. The weight percent of vinyl acetate in EVA usually varies from 10% to 40%, with the remainder being ethylene. Further, as is known to those of ordinary skill in the art, solvent-based adhesives generally contain a higher level of organic solvents than non-solvent-based adhesives. The function of organic solvents in an adhesive relates to certain properties they bring—they facilitate application and drying of the adhesive. During application and drying, the solvent evaporates. Ideally the adhesive, once dry, no longer contains solvent.

In one embodiment, the adhesive of label 10 may include EVA, and may be a “warm melt” adhesive. As is known to those of ordinary skill in the art, warm melt adhesives are a class of adhesives that exhibit properties of hot melt adhesives and versatility of hot melt adhesives, but can be applied at much lower temperatures without a loss of performance relative to hot melt adhesives. As described above, primary advantages of warm melt adhesives include reduced cost, reduction or removal of hazardous air pollutants (HAPs) and VOCs from the application process, and a resulting lack of need or reduced need for air pollution control devices.

As is known to those of ordinary skill in the art, hot melt adhesives are generally thermoplastics applied in molten form (e.g., in the 65-180° C. range) that solidify on cooling to form strong bonds between materials. Ethylene-vinyl acetate based hot-melts are one type of hot-melt adhesives. They are often used because of their ease of use and the wide range of common materials they can join.

In industrial use, hot melt adhesives provide several advantages over solvent-based adhesives. Volatile organic compounds are reduced or eliminated, and the drying or curing step is eliminated. Hot melt adhesives have long shelf life and usually can be disposed of without special precautions. Further, HMAs do not lose thickness during solidifying; solvent-based adhesives may lose up to 50-70% of layer thickness during drying.

Hot melt adhesives are usually based on one or more base material (such as EVA), with various additives. The composition is usually formulated to have glass transition temperature below the lowest service temperature and a high melt temperature. Typical base materials may include ethylene-vinyl acetate, polyolefins, polyamides, polyesters, and polyurethanes, styrene block copolymers, and polycarbonates, for example. Typical additives include tackifying resins, antioxidants, stabilizers, antistatic agents, and fillers, for example. One example of a hot melt adhesive may include EVA as a base material, having a vinyl acetate monomer content of about 18-29% by weight of the polymer, the EVA being combined with tackifiers; an exemplary composition is 30-40% of EVA copolymer, 30-40% of tackifier resin, 20-30% of wax (usually paraffin-based), and 0.5-1% stabilizers.

Thus, in this embodiment, the present invention provides a warm-melt adhesive, which may be an EVA-based adhesive, for use with shrink films, to incorporate some properties of hot melt adhesives, while being suitable for use with shrink films, such as, for example, having lower application temperatures and lower temperatures at which tackiness develops than those found with hot melt adhesives. Thus, as the particular formulation has these lower temperatures, the adhesive can be applied proximal to the inner surface of a shrink film without prematurely deforming/shrinking the shrink film.

In one embodiment, the EVA warm melt adhesive is supplied in gel form. And because it is applied at high temperatures (though not as high as adhesives such as hot melt adhesives), it is capable of having a higher durometer (i.e., hardness of the material) at ambient conditions. The warm melt EVA adhesive of the present invention differs from other heated shrink sleeve label adhesive systems. Other shrink sleeve label adhesive systems include adhesives that are applied only at ambient temperatures or slightly higher (e.g., 85° F.). Further, the adhesives used in these other prior shrink sleeve adhesive systems have high costs, have a higher percentage of HAPs in diluents, and exhibit a lower cohesive bond strength.

The warm melt adhesive used in the present invention, however, is provided as a gel, and is applied proximal to the inner surface of the shrink sleeve via a gravure cylinder, for example. In such an embodiment, a gravure cylinder includes etchings in a surface thereof, which allows the adhesive to be printed proximal to the inner surface 14 of the shrink film 12 in a particular pattern, such as a strip pattern. Further, the gel is heated prior to application because, without heat, it will not release from the cylinder. In one embodiment, the application temperature may be at or lower than about 120° F., and may be in a range of about 115° F. to about 120° F. The high temperature application also allows the EVA copolymer of the adhesive to coalesce, i.e., meld together to form a coherent film, thereby improving the cohesive bond strength of the adhesive. This, in turn, provides a shrink sleeve label that bonds to an article in such manner that it cannot be removed without damaging or destroying the label, thereby preventing its removal and re-use.

The adhesive 16 also may operate at a temperature or temperatures that allows application to the shrink film and bonding to the article to occur, while remaining compatible with the temperatures used to apply and shrink the shrink sleeve to the article. During shrinking of the shrink sleeve 12 to the article 20, temperatures generally need to be high enough to cause shrinking of the film, and yet low enough to avoid deforming, or otherwise damaging, the article 20. Thus, the adhesive 16 needs to develop tack in a temperature range similar to the temperatures used to shrink the film. The adhesive 16 develops tack at a temperature lower than a temperature that would cause deformation of the article 20. In one embodiment, the adhesive 16 may develop tackiness in a range of 130° F. to 150° F., and in one particular embodiment develops tackiness at about 140° F. (and tackiness would be present at temperatures thereabove). Further, in certain embodiments, a tunnel exit temperature of about 165° F. may be used for the development of tackiness of the adhesive.

The adhesive includes an increased percentage of solids compared to other shrink sleeve label adhesives. Generally, typically used ambient temperature applied adhesives have a content of about 20% to 24% solids—and usually have a content of around 24% solids. However, the warm melt adhesives, such as those used in aspects of the present invention, may include about 25% or more solids, and in certain embodiments may include about 30% or more solids. (These are percentages prior to any press side diluent adds for viscosity or coat-weight adjustment.) This higher percentage of solids results in a decreased percentage of VOC levels compared to other shrink sleeve label adhesives. In particular, in one embodiment the adhesive may have 25%-35% non-volatile components. And in another embodiment, the adhesive may be 30% non-volatile components. Thus, the adhesive also has the advantage of not being as hazardous as other adhesives used with shrink sleeves. In one example, the adhesive may have a viscosity of 125 to 225 cps at 40° C., a weight per gallon of about 5 lbs to about 10 lbs at 77° F., develop tackiness at a temperature of about 140° F., and may show resistance to blocking when heated to about 115° F. to about 125° F. and a pressure of about 3 psi to about 5 psi for 2 hours. In one specific embodiment, the adhesive may have a viscosity of 125 to 225 cps at 40° C. and a weight per gallon of about 6.80 lbs to about 7.60 lbs at 77° F., for example, 7.20 lbs at 77° F. The adhesive may develop tackiness at a temperature of about 140° F. And the adhesive may show resistance to blocking when heated to 120° F. and a pressure of 4 psi for 2 hours. One particular such adhesive is Proxseal® J9732E In-Mold Label Lacquer, commercially available from Henkel Corporation, of Buffalo, N.Y. As applied, the adhesive may have a coat weight of about 6.8 lbs per ream to about 7.6 lbs per ream.

In one embodiment, the adhesive 16 may be disposed proximal to the inner surface 14 of the shrink film 12. And, as described above, the adhesive may be disposed in a pattern, such as the strip pattern particularly described. In one embodiment, the adhesive 16 may have a coat weight in a range of about 0.50 lb/ream to about 3.00 lb/ream. In another embodiment, the adhesive 16 may have a coat weight in a range of about 1.25 lb/ream to about 1.75 lb/ream. And in another particular embodiment, the adhesive 16 may have a coat weight of about 1.25 lb/ream. A ream is typically 3000 ft².

In alternate embodiments, as described above, in another aspect of the present invention, the adhesive 16 may be applied proximal to the inner surface 14 of the shrink sleeve 12 in a pattern that prevents transfer of adhesive from shrink sleeve to bullet (or other portion of label application apparatus). One such pattern that will be described in greater detail below is a strip pattern. Others may include a pattern of adhesive droplets.

More specifically, the adhesive 16 may be applied proximal to the inner surface 14 of the shrink sleeve 12 in a strip pattern (see FIG. 2), as opposed to a full flood coating of adhesive in the inner surface of the sleeve. In certain embodiments, the application of the adhesive in a strip pattern assists in preventing a substantial amount of adhesive being removed from the shrink sleeve and building up on the bullet of the label application apparatus. For example, the adhesive may be applied in a plurality of distinct strips 38 that are linear and substantially parallel to other strips with a gap of no adhesive in between. The strips 38 may be applied in a direction that is parallel to the longitudinal axis of the bullet that the shrink sleeve passes over during the application process. As a result, the build-up of adhesive on the bullet due to transfer from the shrink sleeve is reduced or eliminated.

As described above, in certain embodiments, the adhesive 16 may be applied in a plurality of distinct strips 38 that are linear and substantially parallel to adjacent adhesive strips with a gap having no adhesive in between those strips (as shown in FIG. 2). As will be recognized by those of ordinary skill in the art, the particular number of strips is not necessary to this aspect of the present invention. For example, even a single strip of adhesive could suffice. This is because, as described above, the primary concern with the adhesive 16 is to include enough to provide a bond between the shrink sleeve 12 and article 20 that prevents removal of the shrink sleeve 12 for counterfeiting purposes, and to prevent removal of the adhesive 16 from the shrink sleeve 12 as it slips past a bullet or other portion of a label application apparatus. Thus, minimizing the number of “strips” to a level that allows one to provide a bond that prevents removal of the shrink sleeve from the article (or causes sufficient damage to the label upon removal that prevents counterfeiting) will enhance the prevention of buildup of adhesive on the bullet or other portion of the label application apparatus. This may be achieved with one strip. However, as will be recognized by those of ordinary skill in the art, the number of strips may be dependent upon the particular adhesive used, the overall coat weight of the adhesive, the temperature of application, etc., all of which are within the purview of one of ordinary skill in the art.

It will be further recognized by those of ordinary skill in the art that while a particular embodiment (strips) is shown in FIG. 2 and described above, other patterns (such as a pattern of adhesive droplets) may suffice, and so the invention is not limited to a strip or strips of adhesive.

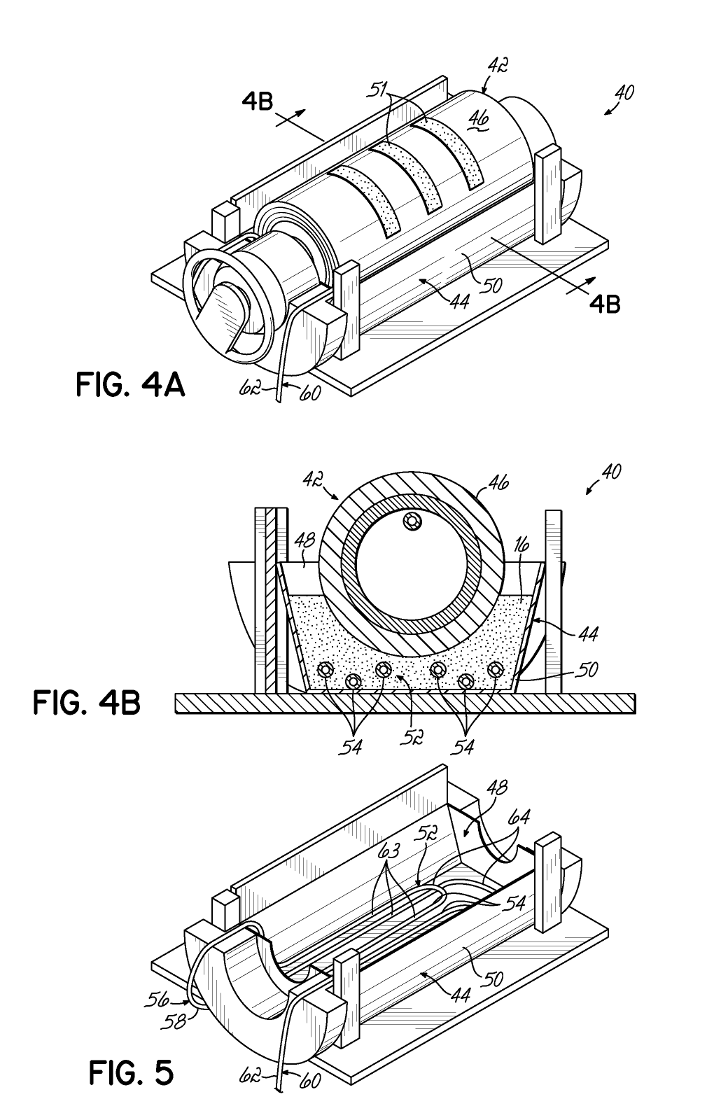

In order to achieve application of the adhesive 16 to the shrink sleeve 12 (and, in certain embodiments, a pattern for the adhesive), and referring now to FIGS. 4A-6, another aspect of the present invention provides apparatus 40 for applying the adhesive to the shrink film 12. In this aspect, the apparatus, which may include one or more components, may include heating element(s) that allow the temperature of the adhesive to be raised, lowered, and/or maintained at various stages of hold or travel in and between apparatus and during application. Those of ordinary skill in the art will recognize that the apparatus depicted in the illustrated embodiment (i.e., in FIGS. 4A-6) is merely an example of apparatus that may be used in accordance with the principles of the present invention. The exemplary apparatus of the illustrated embodiment includes a cylinder 42 and tray 44. The cylinder 42 may be a gravure cylinder, for example, and the tray 44 may be amenable for use with the gravure cylinder 42. The gravure cylinder 42 is held proximate to, and at least partially within, the tray 44 and rotates such that an outer surface 46 of the cylinder 42 can enter and exit an interior compartment 48 defined by walls 50 of the tray 44 as the cylinder 42 rotates. The purpose of the tray 44 is to hold adhesive 16 during the process of adding adhesive to the label 10. The cylinder may be etched with a pattern 51 to correspond to the pattern of adhesive 16 (e.g., “strip” or “strips” 38) desired to be applied proximal to the shrink film 12.

Further, in certain embodiments, it may be desirable to apply the adhesive in a heated state and to maintain the adhesive at a particular temperature prior to and/or during application. Thus, the tray 44 and/or cylinder 42 may be associated with a heating element or heating component(s) which control the temperature of the adhesive 16 in the tray 44. As is known to those skilled in the art, there may be different forms and apparatus of such elements or components. For example, in one particular illustrated embodiment, a manifold 52 is positioned in the tray 44. The manifold 52 includes at least one pipe 54 that is supplied with steam under pressure. In the illustrated embodiment, the manifold 52 includes a series of pipes 54 that are supplied with steam under pressure. Thus, the pipe or pipes 54 that comprise the manifold 52 include a steam inlet 56 at a first end 58 thereof and a steam outlet 60 at a second end 62 thereof. Steam is introduced to the manifold 52 via the steam inlet 56. The steam supplied to the manifold 52 increases the temperature of the manifold 52, and the radiant heat therefrom increases the temperature of the adhesive, or maintains the already increased temperature of the adhesive, which is in the tray 44.

More specifically, and referring to FIG. 5, the apparatus 40 includes a tray 44, in which the gravure cylinder 42 is held and spins (i.e., rotates within it), and a manifold 52 associated with the tray 44. The manifold 52 of the illustrated embodiment includes a series of pipes 54 having substantially parallel sections 63, interconnected by curved portions 64 at their ends, that are supplied with steam under pressure in order to be able to heat the adhesive in order to cause the adhesive to achieve a “printable” viscosity. The manifold 52 may be a separate component that is removably coupled to the tray 44. Alternatively, the manifold 52 may be permanently affixed to the tray 44. Further, while the manifold 52 of the illustrated embodiment includes pipes 54 of substantially parallel sections 63 and curved portions 64, it will be recognized by those skilled in the art that this particular configuration is not necessary. Rather, any configuration that provides a component or components to sufficiently heat the adhesive will suffice.

In the apparatus of the illustrated embodiment, as described above, the temperature of steam is increased in the manifold 52, which is positioned near or at the bottom of the tray 44. The adhesive is added into the tray 44 (such as by being pumped by a pump from a heated tank), and so the manifold 52 provides heat to the adhesive 16, to increase the temperature of the adhesive 16 such that the adhesive will achieve and/or remain at a desired temperature. This adhesive temperature may be in the range of about 110° F. to about 130° F., although it will be recognized by those skilled in the art that a particular temperature or range of temperatures needed may fluctuate, depending on the particular adhesive used.

Additionally, and referring now to FIG. 6, the apparatus used in preparing a label 10 or labels 10 in accordance with aspects of the present invention, may also include a tank 78 associated with a heating element 80 and a pump 82 associated with a heating element 84. These components are used to heat, and soften, the adhesive prior to adding the adhesive to the gravure tray 44. In one particular embodiment, the tank 78 may be a 55 gallon steel drum, into which solid adhesive is placed. In one specific embodiment, the heating element 80 may include a drum heating coil (not shown), which may be a three zone heating unit that is wrapped around the exterior of the drum. The coil of this embodiment is then heated to increase the temperature in the interior of the drum, thereby heating, and softening, the adhesive. The drum heating coil may be a standard heating coil as is well known to those skilled in the art. Additionally, as described above, the drum heating coil may be a three zone heating coil. Such a heating coil, as is known to those skilled in the art, may have heat supplied to different zones at different times. For example, when the drum is filled with adhesive, all three zones of the drum heating coil may be heated in order to supply heat to the entire drum. As the now-softened adhesive is removed from the drum and transported to the tray 44, the upper zone may be shut off. As the level of adhesive continues to drop, the middle zone may be shut off. Should the drum be emptied, the lower zone may be shut off as well. Also, as more adhesive is added to the drum, zones (such as the middle and upper zones) may be turned back on. As will be recognized by those of ordinary skill in the art, the heating coil is merely an example of one type of heating element 80 that may be used to heat the tank 78 and the contents thereof.

A temperature controller may be used to control the heating of the coil and thus the temperature of the adhesive in the interior of the tank 78. In one embodiment, the tank temperature may have a minimum of 140° F. Once the adhesive is softened, it may be transported through a line 85 (which may also be heated) and into the tray 44 by use of the pump 82. Thus, the adhesive is heated in the tank to a flowable temperature and viscosity, and the manifold and heated mandrel maintain this temperature and viscosity in the tray 44 and on the cylinder 42, respectively. The pump itself may be heated (in one embodiment to a minimum of 120° F.).

Thus, the apparatus of this aspect of the present invention (still referring to FIG. 6) includes a gravure printing unit for a rotary press, with a gravure cylinder 42 (which may include a heated mandrel 66) supplied with adhesive from the manifold-heated gravure tray 44 and an impression roller 86, which lies in confronting relationship to the gravure cylinder 42, in the illustrated embodiment, to form a roller gap 88 therebetween. When the rotary press is running, a film, such as shrink film 12, that is to be printed with adhesive is passed through the roller gap 88, taking up adhesive from the peripheral surface of the gravure cylinder 42. At the same time, the gravure cylinder 42 rotates in a specified direction opposite to that of the impression roller 86 and its rotational movement is composed of a leading, rotating sector from the printing unit to the roller gap 88 and a trailing rotating sector from the roller gap 88 to the printing unit.

In the case of the gravure printing unit, the printing sites of the gravure cylinder 42 forming the printing forms are recessed in the manner characteristic for gravure printing in the form of gravure cells of optimally different depth and/or area for holding the adhesive. The excess adhesive of the gravure cylinder 42, supplied with adhesive from the gravure tray 44, may be removed by a doctor blade (not shown) or a similar stripping device. As the film 12, which is to be printed, is passed through the roller gap 88 formed between the gravure cylinder 42 and the impression roller 86, the adhesive is transferred out of the gravure cells and proximal the film 12 (i.e., onto the film 12, or onto any intervening surface between the film and the adhesive).

Referring back to FIGS. 1A-1D, the invention may further include an ink layer 36 disposed proximal to the inner surface 14 of the shrink sleeve 12. “Disposed proximal to,” as used here, means that although the ink is applied to the same side as a surface (i.e., the inner surface 14) of the shrink sleeve 12, it is not necessary that there be any direct contact between the ink and the surface (although there may be). For example, another layer or layers may be disposed between the ink and the surface that the adhesive 16 is “disposed proximal to.”

The invention of the illustrated embodiment thus includes an adhesive layer 16 disposed proximal to the ink layer 36, such that the ink layer 36 is disposed between the inner surface 14 of the shrink sleeve 12 and the adhesive layer 16 (see FIG. 2). The ink layer 36 may further include a background white ink. Many labels include a specific background white ink as the “last-down” ink to provide a contrast to the other graphics of the label. Thus, the background white ink is the ink of the ink layer 36 that may directly contact any adhesive layer 16. While the background ink is described as a “background white ink,” it will be recognized that the background ink need not be white, but can be any other color desired. In particular, the ink may include a plasticized nitro-acrylic based resin including a pigment load (such as TiO₂), and a wax additive. The resin may also be a nitro resin. The wax additive may be PTFE, for example. The wax additive promotes the adhesive layer laying out smoothly on the surface of the ink layer, rather than seeping into the ink layer. This, in turn, promotes adhesion of the laminate to an article to which it is applied.

Thus, using the shrink sleeve film 12, adhesive 16, and inks described above, the present invention also provides a label 10 including a film for a shrink sleeve 12, an ink layer 36 disposed on the inner surface 14 of the shrink sleeve 12, and an adhesive layer 16 disposed on the ink layer 36.

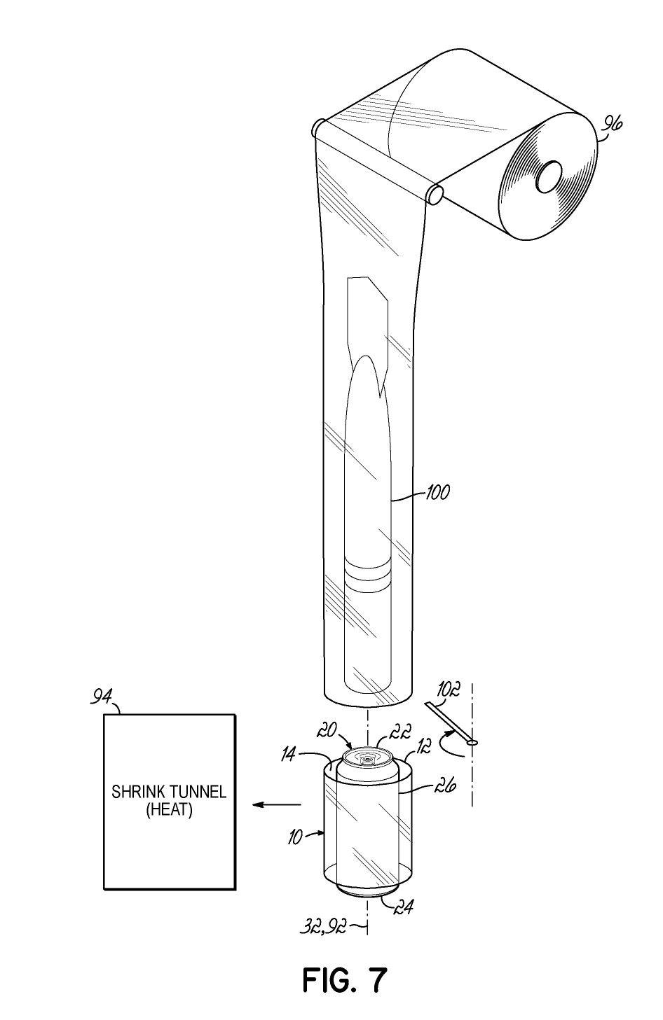

Finally, and referring to FIG. 7, another aspect of the present invention provides a method of applying a shrink sleeve over an article. The method includes providing a shrink sleeve having an axis of symmetry and at least one decoration visible on an outer surface of the shrink sleeve, with an adhesive on the inner surface thereof. The adhesive used is of a particular formulation that it is not substantially removed from the shrink sleeve and does not build up on a label application apparatus during application of shrink sleeve to article. The adhesive may also be in a particular pattern (such as a strip pattern), to further prevent build-up of adhesive on a label application apparatus. One also provides an article, the article having a top end, a bottom end, a side surface, and a longitudinal axis passing through a centerpoint of the top end and a centerpoint of the bottom end. The article is oriented such that the longitudinal axis is substantially parallel to the axis of symmetry. The shrink sleeve is positioned over and around the article such that at least a portion of the article is disposed within and substantially surrounded by the shrink sleeve. And the shrink sleeve is shrunk such that the shrink sleeve constricts around at least a portion of the side surface of the article, thereby positioning the shrink sleeve such that the at least one decoration is visible on an outer surface of the shrink sleeve.

More specifically, this method includes the steps of first providing a shrink sleeve 12 generally as described above, which has an axis of symmetry 92. The method of the present invention also includes providing an article 20 having a top end 22, a bottom end 24, a side surface 26, and a longitudinal axis 32 passing through a centerpoint 28 of the top end 22 and a centerpoint 30 of the bottom end 24. This article 20 is then oriented such that the longitudinal axis 32 of the article 20 is substantially parallel to (and/or coaxial with) the axis of symmetry 92.

Next, the shrink sleeve 12 is positioned over and around the article 20 such that at least a portion of the side surface 26 of the article 20 is disposed within and substantially surrounded by the shrink sleeve 12. Finally, the shrink sleeve 12 is shrunken such that the inner surface 14 of the shrink sleeve 12 constricts around a portion of the side surface 26 of the article 20.

In general, the method of the present invention also allows for applying shrink sleeves 12, which may include labels, to article 20 by moving the article 20 into proximity with a source of shrink sleeve 12 film, positioning a strip of tubular shrink sleeve 12 around each article 20, and heating the shrink sleeve 12 to shrink it against the article 20. Additionally, the method includes severing the shrink sleeve 12 between adjacent labels 10 to separate them into individual shrink sleeves 12, each associated with one such article 20. In one particular embodiment of the invention, the shrink sleeves 12 are heat-shrunken on the articles 20 using hot air in a shrink tunnel 94, through which the articles 20 and associated shrink sleeve films 12 are moved.

In the illustrated embodiment of the present invention, the shrink sleeve apparatus includes a roll 96 from which the plastic shrink sleeve 12 is dispensed, a bullet 100, a cutoff device 102, and a shrink tunnel 94. In particular, a master roll 96 of shrink film is prepared with a number of label copies across its surface. The particular number of labels depends upon the size of the label copy and the width of the master roll 96. The printed rolls 96 are then slit-cut, thereby forming individual rolls 96 containing one copy of the label only. The slit rolls 96 are then folded and overlapped, and seamed at the edge, forming a shrink sleeve 12 that is wound on a core.

In operation, an article 20, such as a bottle or can, is guided underneath the bullet 100. The bullet 100 is aligned with the shrink sleeve film 12, which is obtained from the roll 96. A shrink sleeve 12 is pulled from the roll 96 and is opened into its tubular form by the blade end of the bullet 100. This tubular shrink sleeve 12 is then slipped past the bullet 100 in order to maintain its tubular form and to guide the shrink sleeve 12 over the article 20. In the present invention, as the articles 20 are positioned proximal to the shrink sleeves 12 and bullet 100, they are positioned such that the longitudinal axis 32 of each article 20 is substantially parallel to (and/or coaxial with) the axis of symmetry 92 of the shrink sleeve 12. After the shrink sleeve 12 is guided and positioned around the article 20, a cutoff device 102 is used to sever the shrink sleeve 12 from the remainder of the roll 96 of film. Next, the article 20 and the loose plastic shrink sleeve 12 proceed through the shrink tunnel 94, which shrinks the shrink sleeve 12 against the article 20 through the application of heat. The heat for shrinking may be provided by steam. Alternatively, heat may be provided by a hot air manifold. Also, heat may be applied by a combination of these methods, for example, steam heat coupled with air movement. A constant heat may be applied to the shrink sleeve 12 and article 20. Alternatively, the shrink sleeve 12 and article 20 may experience gradations of temperature as they move through the shrink tunnel 94. In one embodiment, heat may be applied to the shrink sleeve 12 and article 20 at a temperature in the range of about 140° F. to about 275° F. Such a shrink sleeve apparatus is commercially available from Nippon Automatic Fine Machinery Company of Anaheim Hills, Calif.

The desired temperature within the shrink tunnel 94 depends upon a number of factors, such as the speed at which the article 20 and plastic shrink sleeve 12 are moved through the tunnel 94, and also the particular composition and thickness of the plastic film. In general, in one embodiment, heat should be applied that will reduce the size of the shrink sleeve 12 up to 77%.

Following shrinking, the article 20 and shrink sleeve 12 may then be cooled by subjecting the shrink sleeve 12 to ambient temperatures to allow for a gradual cooling process. Alternatively, the shrink sleeve 12 may undergo other cooling steps, such as subjecting the shrink sleeve 12 to cool air or liquid.

Further, aspects of the present invention may include certain apparatus for heating the adhesive prior to and during application. For example, in one embodiment, such apparatus may include industrial ovens to pre-heat the adhesive, a heated tank (wherein the adhesive is pumped into the tank out of drums), a heated pump (which pulls the adhesive from the tank), and a heated gravure pan.

Further still, aspects of the present invention may include certain temperature ranges or temperatures at which the adhesive is held or applied. For example, in one embodiment, there may be an application temperature (adhesive in pan temperature) in a range of about 110° F. to 130° F. Additionally, in this embodiment, there may be a pump temperature having a minimum of 120° F., a tank temperature having a minimum of 140° F., and a web temperature exit target in a range of 110° F. to 130° F. In one particular embodiment, the application temperature may be about 120° F., and the web temperature exit target may be about 120° F. Further, in one embodiment, the adhesive can be pre-conditioned by heating to a temperature in the range of about 130° F. to about 150° F. twenty-four hours prior to the coating application. In one specific embodiment, this preconditioning may occur at a temperature of about 140° F.

In the aspect of applying the shrink sleeve label to the article (described above), certain embodiments may include one or more various application conditions. For example, in one embodiment, the adhesive is preconditioned at 140° F. for 24 hours prior to coating onto the inner surface of the shrink film. In another embodiment, certain equipment may be used during application. For example, a heated adhesive pan, pump, and tank can be used when applying an adhesive (such as a warm melt EVA based adhesive). In another embodiment, the adhesive can be applied to shrink film at about 120° F.

Further, in one exemplary embodiment, the process described above may occur with a web tension of about 0.5 lbs to 1.2 lbs per linear inch, and in one embodiment may have a web tension of 0.9 lbs per linear inch. Further, the viscosity of the adhesive may be about 18 to about 21 seconds (3 zahn), though this can vary depending on the coat weight, as is known to those of ordinary skill in the art.

While the various aspects of the present invention have been disclosed by reference to the details of various embodiments of the invention, it is to be understood that the disclosure is intended as an illustrative rather than in a limiting sense, as it is contemplated that modifications will readily occur to those skilled in the art, within the spirit of the invention and the scope of the appended claims.

What is claimed is:

1. A label comprising:
a shrink film having a warm-melt adhesive proximal to an inner surface of said shrink film;
wherein said shrink film is adapted to be shrunk around at least said side surface of an article, to confront said side surface, and said shrink film further includes at least one visible decoration on a surface of said shrink film.

2. The label of claim 1, wherein the warm-melt adhesive includes ethylene vinyl acetate.

3. The label of claim 1, wherein the warm-melt adhesive is a solvent based adhesive.

4. The label of claim 3, wherein the solvent-based adhesive further includes ethylene vinyl acetate.

5. The label of claim 1, wherein the adhesive is about 25% solids or greater, prior to press side diluent adds for viscosity or coat-weight adjustment.

6. The label of claim 1, wherein non-volatile components comprise 25% or more of the adhesive.

7. The label of claim 1, wherein the adhesive has a viscosity of 125 to 225 cps at 40° C. and a weight of about 6.8 lbs per ream to about 7.6 lbs per ream.

8. The label of claim 1, wherein the adhesive develops tackiness at about 140° F.

9. The label of claim 1, wherein the adhesive does not include a binder and is not encapsulated.

10. A label comprising:
a shrink film having an adhesive proximal to an inner surface of said shrink film;
wherein said shrink film is adapted to be shrunk around at least said side surface of an article, to confront said side surface, and said shrink film further includes at least one visible decoration on a surface of said shrink film; and
wherein the adhesive is present as a patterned coating proximal to the inner surface of said shrink film.

11. The label of claim 10, wherein the patterned coating comprises at least one strip of adhesive parallel to a longitudinal axis of the shrink film.

12. The label of claim 11, wherein the patterned coating comprises a plurality of strips of adhesive, each of said plurality of strips of adhesive being parallel to a longitudinal axis of the shrink film, and each strip of adhesive being spaced from each of the other of the plurality of strips of adhesive.

13. The label of claim 10, wherein the adhesive is a solvent-based adhesive.

14. The label of claim 13, wherein the solvent-based adhesive includes ethylene vinyl acetate.

15. The label of claim 13, wherein the solvent-based adhesive is a warm-melt solvent based adhesive.

16. The label of claim 15, wherein the solvent-based adhesive further includes ethylene vinyl acetate.

17. The label of claim 10, wherein the adhesive is about 25% solids or greater, prior to press side diluent adds for viscosity or coat-weight adjustment.

18. The label of claim 10, wherein non-volatile components comprise 25% or more of the adhesive.

19. The label of claim 10, wherein the adhesive has a viscosity of 125 to 225 cps at 40° C. and a weight of about 6.8 lbs per ream to about 7.6 lbs per ream.

20. The label of claim 10, wherein the adhesive develops tackiness at about 140° F.

21. The label of claim 10, wherein the adhesive does not include a binder and is not encapsulated.

22. A label comprising:
a shrink film having a solvent-based adhesive proximal to an inner surface of said shrink film;
wherein said shrink film is adapted to be shrunk around at least said side surface of an article, to confront said side surface, and said shrink film further includes at least one visible decoration on a surface of said shrink film.

23. A decorated article, the article used to package an item or items, the decorated article comprising:
a shrink film having a solvent-based adhesive proximal to an inner surface of said shrink film; and
an article having a top end, a bottom end, and a side surface;
wherein said shrink film is shrunk around at least said side surface of said article, to confront said side surface, and said shrink film further includes at least one visible decoration on a surface of said shrink film.

24. The decorated article of claim 23, wherein the solvent-based adhesive includes ethylene vinyl acetate.

25. The decorated article of claim 23, wherein the solvent-based adhesive is a warm-melt solvent based adhesive.

26. The decorated article of claim 25, wherein the solvent-based adhesive further includes ethylene vinyl acetate.

27. The decorated article of claim 23, wherein the adhesive is about 25% solids or greater, prior to press side diluent adds for viscosity or coat-weight adjustment.

28. The decorated article of claim 23, wherein non-volatile components comprise 25% or more of the adhesive.

29. The label of claim 23, wherein the adhesive has a viscosity of 125 to 225 cps at 40° C. and a weight of about 6.8 lbs per ream to about 7.6 lbs per ream.

30. The label of claim 23, wherein the adhesive develops tackiness at about 140° F.

31. The label of claim 23, wherein the adhesive does not include a binder and is not encapsulated.
